(19) United States
(12) Patent Application Publication
(10) Pub. No.: US 2011/0287731 A1
(43) Pub. Date: Nov. 24, 2011

(54) ANTENNA AND RECEPTION APPARATUS PROVIDED WITH ANTENNA

(76) Inventor: Kazutoshi Hase, Osaka (JP)

(21) Appl. No.: 13/146,328

(22) PCT Filed: Jan. 28, 2010
(86) PCT No.: PCT/JP2010/000477

§ 371 Date: Jul. 26, 2011

(30) Foreign Application Priority Data
Feb. 2, 2009 (JP) 2009-021166

(51) Int. Cl. H04B 7/00; H01Q 21/00

(52) U.S. Cl. 455/269; 343/727

(57) ABSTRACT

An antenna is capable of receiving radio waves, including a monopole antenna connected to a first feeding point and formed of a first linear line; and a dipole antenna including plural linear lines connected to a second feeding point. The dipole antenna is composed of a second linear line made of plural linear lines disposed substantially equidistant from the first linear line and substantially parallel to the first linear line; and a third linear line substantially orthogonal to the second linear line. Electric currents are excited through the plural linear line forming the second linear line in directions opposite to each other. The monopole antenna is on substantially the same plane as the dipole antenna.

### TECHNICAL FIELD

The present invention relates to an antenna for receiving radio waves such as broadcast signals and to a reception apparatus including the antenna, particularly to a reception apparatus equipped with a dipole antenna and a monopole antenna.

### BACKGROUND ART

As shown in FIG. 8A, there is known a conventional configuration for forming a dipole antenna in which linear-shaped dipole antenna 802 extended in directions 180 degrees from each other (bilaterally symmetric) attached to the front end of cable 800. This configuration features an extremely simple structure for forming an antenna.

Meanwhile, a conventional dipole antenna is unable to receive radio waves in the orthogonal direction. FIG. 8B shows dipole antenna 802 in FIG. 8A viewed from the above. FIG. 8B shows directional characteristic 804 of dipole antenna 802. As shown in FIG. 8B, dipole antenna 802, with its horizontal directivity, can receive horizontal radio waves; however, without its vertical directivity, is unable to receive vertical radio waves.

To solve such a problem, there is known a configuration in which a monopole antenna is closely disposed in a substantially orthogonal direction on the symmetry axis of the dipole antenna (refer to patent literature 1 for example). As shown in FIG. 9, this configuration enables receiving radio waves both in horizontal and vertical directions by closely disposing monopole antenna 2 in the direction orthogonal to dipole antenna 1 formed of at least loop-shaped line 4 and feeding point 5.

In the configuration of patent literature 1, however, monopole antenna 2 is disposed in the z-axis direction, where dipole antenna (loop-shaped line) 1 is assumed to be disposed on the xy plane, making a three-dimensional configuration. Accordingly, it is difficult to downsize the antenna itself.

As shown in FIG. 10, patent literature 1 further describes a configuration including inverted F antenna 11 (one type of monopole antenna 2) instead of monopole antenna 2. Even in this case, however, the antenna involves some distance in the z-axis direction, making difficult to downsize the antenna itself in the same way as in FIG. 9.

### PRIOR ART DOCUMENT

### Patent literature

[Patent literature 1] Japanese Patent Unexamined Publication No. 2005-347958

### SUMMARY OF THE INVENTION

An antenna of the present invention, capable of receiving radio waves, includes a monopole antenna and a dipole antenna. The monopole antenna is connected to a first feeding point and is formed of at least a first linear line. The dipole antenna is connected to a second feeding point and is formed of plural linear lines. The dipole antenna includes a second linear line and a third linear line. The second linear line has plural linear lines disposed substantially equidistant from the first linear line and substantially parallel to the first linear line. The third linear line is connected to the second linear line and is formed substantially orthogonal to the second linear line. Electric currents are excited through the plural linear lines of the second linear line of the dipole antenna in directions opposite to each other. The monopole antenna is formed on substantially the same plane as the dipole antenna.

This configuration enables the antenna of the present invention to receive both horizontally and vertically polarized waves. Further, the monopole antenna is disposed inside the space of the dipole antenna. Hence, the antenna can be downsized because the monopole antenna is formed on substantially the same plane as the dipole antenna. Further, the plural linear lines forming the second linear line are substantially equidistant from the monopole antenna, and electric currents are excited through the lines in directions opposite to each other. Hence, although the monopole antenna is disposed inside the space of the dipole antenna, the monopole antenna can receive radio waves without being influenced by the dipole antenna.

The dipole antenna of the antenna of the present invention may have the following structure. That is, the dipole antenna is further connected to a third linear line and includes a fourth linear line formed substantially orthogonal to the third linear line; the fourth linear line is away from the monopole antenna by not smaller than λ/4.

The antenna of the present invention may have the following structure. That is, the monopole antenna includes a fifth linear line formed substantially orthogonal to the first linear line, which is connected to the first feeding point.

The antenna of the present invention may have the following structure. That is, the antenna further includes a sixth linear line formed on substantially the same plane as the dipole antenna, whose angle of disposition with respect to the monopole antenna is changeable; and the sixth linear line can receive both vertically and horizontally polarized waves.

The antenna of the present invention may have the following arrangement. That is, the angle at which the sixth linear line is disposed has been changed so as to receive either vertically or horizontally polarized waves received by the monopole or dipole antenna, whichever exhibits a higher reception level.

The antenna of the present invention may have the following arrangement. That is, the angle at which the sixth linear line is disposed has been changed so as to receive vertically or horizontally polarized waves in the direction opposite to that in which the first linear line is formed from the first feeding point.

With the antenna of the present invention, at least one of the monopole and the dipole antenna may be resin-sealed and fixed to.

A reception apparatus of the present invention includes an antenna capable of receiving radio waves, where the antenna includes a monopole antenna and a dipole antenna. The monopole antenna is connected to a first feeding point and is formed of at least a first linear line. The dipole antenna is connected to a second feeding point and includes plural linear lines. The reception apparatus includes a demodulating unit for demodulating radio waves received by either the monopole or the dipole antenna. The dipole antenna includes a second linear line and a third linear line. The second linear line is formed of plural linear lines disposed substantially equidistant from the first linear line and substantially parallel to the first linear line. The third linear line is formed substantially orthogonal to the second linear line. Electric currents are excited through the plural linear lines forming the second linear line in directions opposite to each other. The monopole antenna is formed on substantially the same plane as the dipole antenna.

A reception apparatus of the present invention includes an antenna capable of receiving radio waves, where the antenna may include three or more different feeding points; an antenna group connected to the feeding points, capable of receiving three or more independent polarized waves; and a demodulating unit for demodulating radio waves received by the antenna group.

### BRIEF DESCRIPTION OF DRAWINGS

FIG. 1 is a conceptual diagram showing the general configuration of an antenna according to an embodiment of the present invention.

FIG. 2 is a conceptual diagram showing an electric current flowing through the antenna according to the embodiment of the present invention.

FIG. 3 is a conceptual diagram showing the general configuration of another example of the antenna according to the embodiment of the present invention.

FIG. 4 is a conceptual diagram showing the general configuration of yet another example of the antenna according to the embodiment of the present invention.

FIG. 5 is a conceptual diagram showing the general configuration of still another example of the antenna and the configuration of a reception apparatus according to the embodiment of the present invention.

FIG. 6 is an explanatory diagram showing operation of further another example of the antenna according to the embodiment of the present invention.

FIG. 7 is a conceptual diagram showing the general configuration of yet further another example of the antenna according to the embodiment of the present invention.

FIG. 8A is a conceptual diagram showing a configuration of a conventional antenna.

FIG. 8B is a block diagram showing a configuration of the conventional antenna.

FIG. 9 is a conceptual diagram showing a configuration of a conventional antenna.

FIG. 10 is a conceptual diagram showing another configuration of a conventional antenna.

### DETAILED DESCRIPTION OF PREFERRED EMBODIMENT

### Exemplary Embodiment

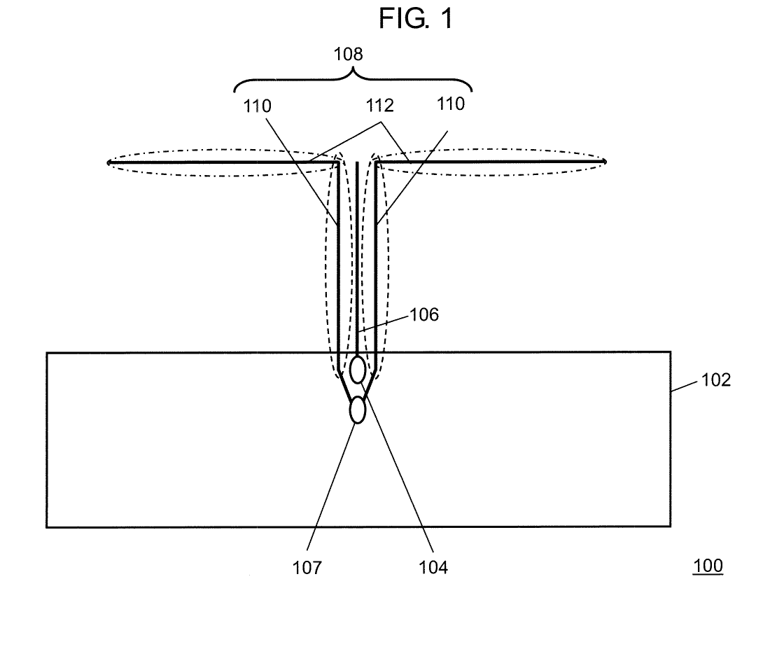

A description is made of a configuration of an antenna according to an embodiment of the present invention referring to FIGS. 1 through 7. FIG. 1 is a conceptual diagram of the general configuration of antenna 100 according to the embodiment.

First, a description is made of a configuration of antenna 100 according to the embodiment referring to FIG. 1. Antenna 100 includes finite ground plate 102; first feeding point 104; first linear line (hereinafter, also referred to as a monopole antenna) 106; second feeding point 107; and dipole antenna 108. Finite ground plate 102 works as a base on which antenna 100 is disposed. Monopole antenna 106 is connected to first feeding point 104 and is formed of first linear line 106. First feeding point 104 is disposed on finite ground plate 102 and plays a role of supplying monopole antenna 106 with high-frequency signals or of receiving high-frequency signals excited in monopole antenna 106. Dipole antenna 108 is connected to second feeding point 107 and is formed of plural linear lines. Second feeding point 107 is disposed on finite ground plate 102 and plays a role of supplying dipole antenna 108 with high-frequency signals or of receiving high-frequency signals excited in dipole antenna 108. Monopole antenna 106 is formed on substantially the same plane as dipole antenna 108.

Here, a detailed description is made of a configuration of dipole antenna 108. Dipole antenna 108 is formed of second linear line 110 and third linear line 112 connected thereto. Second linear line 110 is disposed substantially equidistant from monopole antenna 106 and substantially parallel to monopole antenna 106. Third linear line 112 is connected to second linear line 110 and is formed substantially orthogonal to second linear line 110.

This configuration enables vertically polarized waves to be received by monopole antenna 106 and horizontally polarized waves by dipole antenna 108.

With the above configuration, antenna 100 of this embodiment can receive both vertically and horizontally polarized waves by monopole antenna 106 and dipole antenna 108. The space of dipole antenna 108 has monopole antenna 106 disposed therein. Hence, the antenna can be downsized because monopole antenna 106 is formed on substantially the same plane as dipole antenna 108.

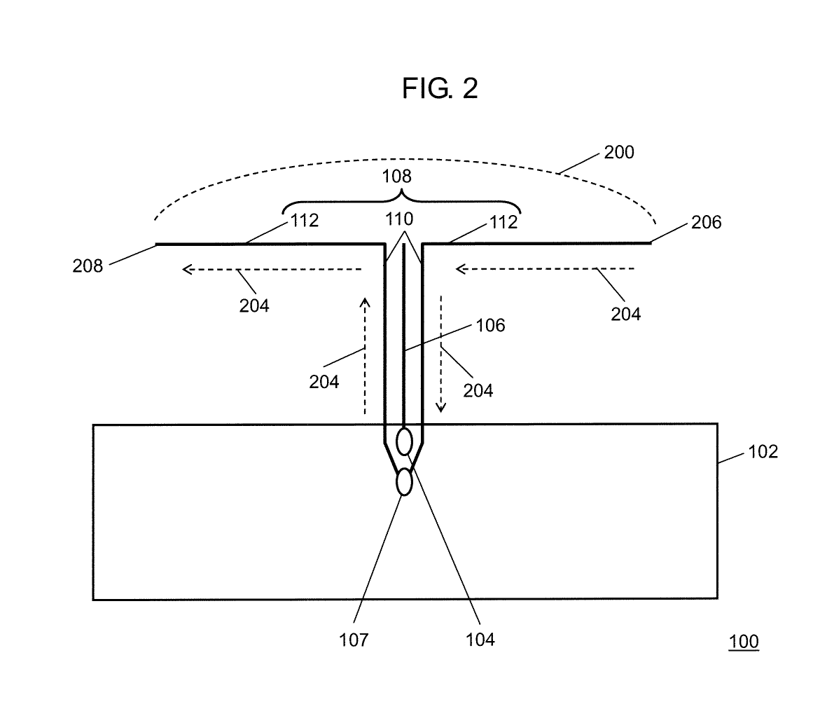

Next, a description is made of an electric current flowing through antenna 100 according to this embodiment referring to FIG. 2. FIG. 2 is a conceptual diagram of an electric current flowing through antenna 100 according to the embodiment. In FIG. 2, broken line 200 (like a part of a substantially elliptical shape) schematically shows the amplitude value of an electric current through dipole antenna 108. Linear arrow 204 schematically shows the direction of an electric current flowing through dipole antenna 108.

As shown in broken line 200, dipole antenna 108 exhibits a maximum electric current value near second feeding point 107. Dipole antenna 108 exhibits a minimum amplitude value near antenna end 206 and antenna end 208. As indicated by linear arrows 204, FIG. 2 shows a state when an electric current has flown from antenna end 206 to antenna end 208 along the direction illustrated, in dipole antenna 108 of the embodiment.

Under such circumstances, a description is made of a magnetic field produced by a electric current flowing through second linear line 110 in monopole antenna 106. Second linear lines 110 are disposed equidistant from monopole antenna 106, and electric currents flow through respective second linear lines 110 in directions opposite to each other. In other words, electric currents are excited in the plural linear lines of second linear line 110 in directions opposite to each other. Hence, magnetic fields produced by electric currents flowing through respective second linear lines 110 of second linear line 110 cancel each other on monopole antenna 106. This results in monopole antenna 106 disposed in an area where a magnetic field is not produced by second linear line 110.

In spite of the fact that monopole antenna 106 and dipole antenna 108 are disposed close to each other, such a configuration enables the antennas to receive polarized radio waves orthogonal to each other, respectively. In other words, the configuration allows monopole antenna 106 to receive polarized radio waves orthogonal to dipole antenna 108 without being influenced by dipole antenna 108.

Antenna 100 according to this embodiment can receive both vertically and horizontally polarized waves by monopole antenna 106 and dipole antenna 108. Further, monopole antenna 106 is disposed within the space of dipole antenna 108, resulting in monopole antenna 106 being formed on substantially the same plane as dipole antenna 108, which allows downsizing. In spite of the fact that monopole antenna 106 and dipole antenna 108 are disposed close to each other, the downsizing allows receiving radio waves without each antenna being coupled (interfering with each other).

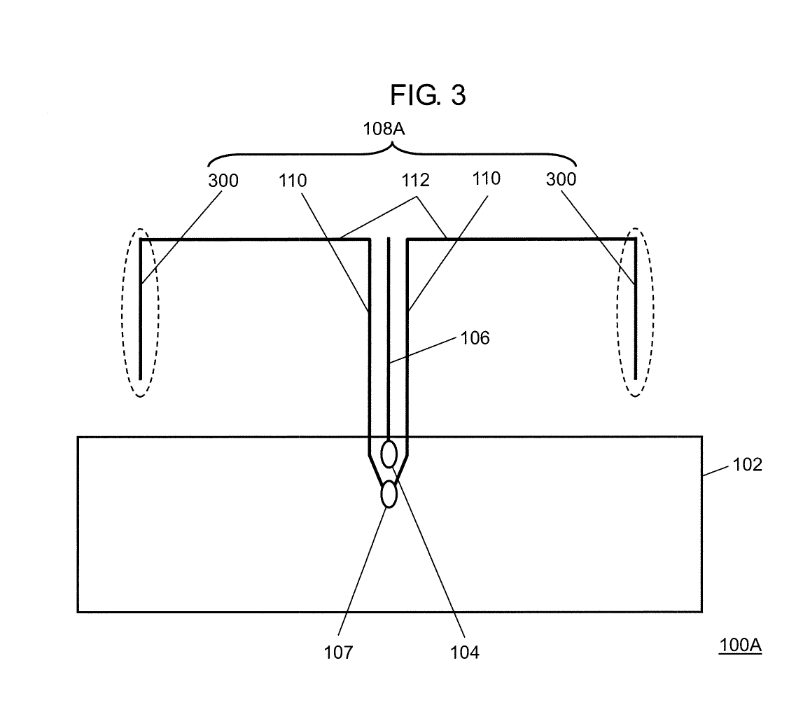

Next, a description is made of a deformed example of dipole antenna 108 of antenna 100 according to the embodiment of the present invention with reference to the related drawings. FIG. 3 is a conceptual diagram showing the general configuration of antenna 100A as another example according to the embodiment of the present invention. As shown in FIG. 3, dipole antenna 108A further includes fourth linear line 300 in addition to dipole antenna 108 shown in FIG. 1. Fourth linear line 300 is connected to third linear line 112. Fourth linear line 300 is formed substantially orthogonal to third linear line 112. Further, fourth linear line 300 is away from monopole antenna 106 by not smaller than λ/4, where λ represents the wavelength of a radio wave having the maximum wave length out of those receivable by antenna 100. As shown in FIG. 3, monopole antenna 106 is formed on substantially the same plane as dipole antenna 108A.

The above configuration, with fourth linear line 300 added, enables antenna 100A according to the embodiment of the present invention to receive radio waves in a wider band and to receive radio waves without fourth linear line 300 and monopole antenna 106 being coupled (interfering with each other).

The above description is made of a configuration in which fourth linear line 300 is connected to third linear line 112; however, antenna 100A of the embodiment is not limited to this configuration, but one piece of bent conducting wire may be used.

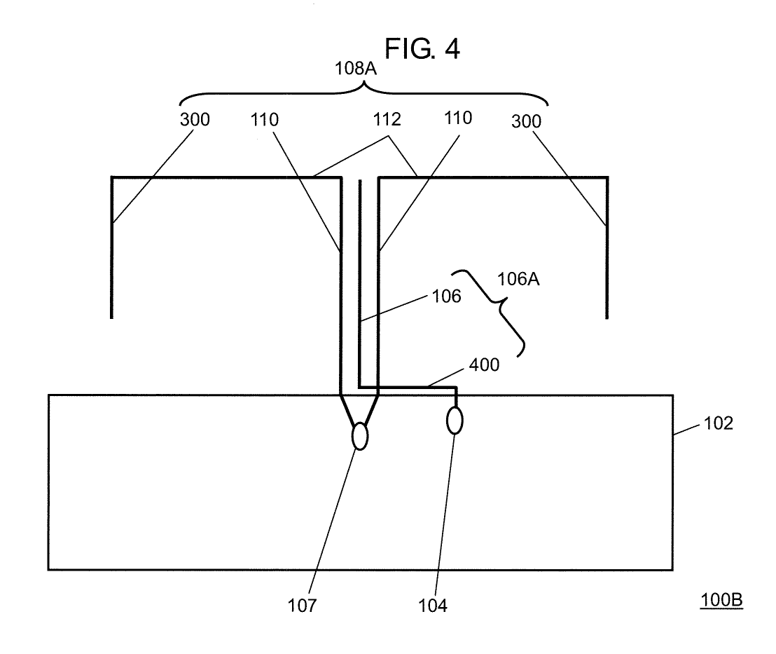

Next, a description is made of a deformed example of monopole antenna 106 of antenna 100 according to the embodiment of the present invention with reference to the related drawings. FIG. 4 is a conceptual diagram showing the general configuration of antenna 100B as yet another example according to the embodiment of the present invention. As shown in FIG. 4, monopole antenna 106A further includes fifth linear line 400 formed substantially orthogonal to monopole antenna (first linear line) 106, in addition to antenna 100A shown in FIG. 3. Fifth linear line 400 is connected to first linear line 106. And fifth linear line 400 is connected to first feeding point 104. In other words, monopole antenna 106A is connected to first feeding point 104 and is formed of at least first linear line 106.

The above configuration, with fifth linear line 400 added, enables antenna 100B according to the embodiment to achieve antenna gain in a broader frequency band than antenna 100A shown in FIG. 3.

That is to say, a shorter line length of monopole antenna 106A can generally receive a signal component at a higher frequency. Hence, a longer line length can receive a signal component at a lower frequency. Compared to antenna 100A shown in FIG. 3, first feeding point 104 and second feeding point 107 can be disposed further away from each other, which reduces interference at feeding points.

The above description is made of a configuration in which fifth linear line 400 is connected to first linear line 106; however, the embodiment is not limited to this configuration, but one piece of bent conducting wire can be used.

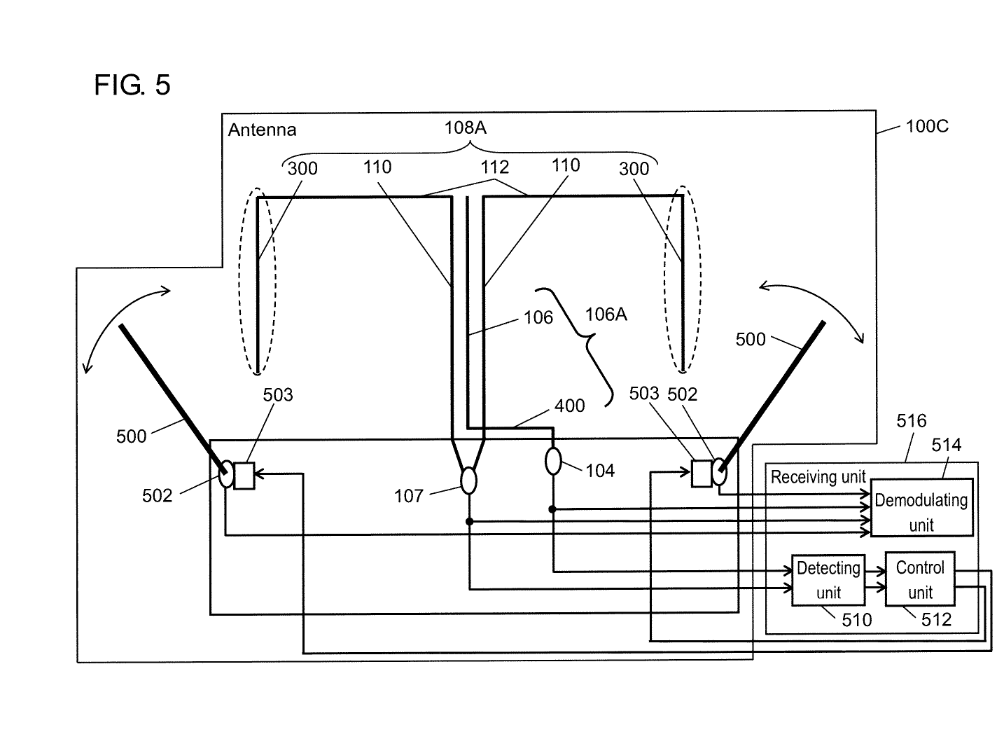

In the above-described embodiment, monopole antennas 106, 106A and dipole antennas 108, 108A, all fixed, as described as a configuration of antennas 100, 100A, and 100B, Hereinafter, a description is made of antenna 100C further including monopole antenna (sixth linear line) 500 whose angle of disposition is variable as shown in FIG. 5. FIG. 5 is a conceptual diagram showing the general configuration of still another example of the antenna and a configuration of a reception apparatus according to the embodiment of the present invention. Here, monopole antenna 500 is connected to third feeding point 502.

The reception apparatus includes antenna 100C and receiving unit 516. Receiving unit 516 includes demodulating unit 514, detecting unit 510, and control unit 512. Demodulating unit 514 is connected to the respective feeding points of monopole antenna 106A, monopole antenna 500, and dipole antenna 108A, and demodulates radio waves received by at least any one of monopole antenna 106A, monopole antenna 500, and dipole antenna 108A. Detecting unit 510 is connected to the respective feeding points of monopole antenna 106A and dipole antenna 108A. Detecting unit 510 detects reception levels of radio waves received by the respective antennas to output a detection signal to control unit 512. The output from control unit 512 is connected to changing mechanism 503 for changing the angle at which monopole antenna 500 is disposed. Then, control unit 512 uses a detection signal received to change the angle at which monopole antenna 500 is disposed with respect to monopole antenna 106. Here, detecting unit 510 may be integrally incorporated into control unit 512.

As described above, antenna 100C of the embodiment receives vertically polarized waves by monopole antenna 106; horizontally polarized waves, by dipole antenna 108A. Additionally, antenna 100C includes monopole antenna (sixth linear line) 500 that can change the angle at which monopole antenna 106 receives polarized waves. Then, antenna 100C rotates monopole antenna 500 using changing mechanism 503 under the control of control unit 512 according to reception conditions, enabling both vertically and horizontally polarized waves to be received by monopole antenna 500. That is, antenna 100C according to the embodiment further includes sixth linear line 500 formed on substantially the same plane as dipole antenna 108A, connected to third feeding point 502, whose angle of disposition with respect to antenna 106A is changeable. Sixth linear line 500 can receive both vertically and horizontally polarized waves.

That is to say, this configuration allows constructing an optimum antenna system according to radio wave conditions even in a case where vertically and horizontally polarized waves are mixed together (e.g. indoor reception). This is because antenna 100C is formed of a total of four linear lines including above-described, fixed monopole antenna 106A and dipole antenna 108A, which enables receiving more radio waves having plural planes of polarization.

As described above, a reception apparatus according to the embodiment includes antenna 100C capable of receiving radio waves, where antenna 100C may include three or more different feeding points; an antenna group connected to the feeding points and capable of receiving three or more independent polarized waves; and demodulating unit 514 for demodulating radio waves received by the antenna group.

The antenna group of the reception apparatus according to the embodiment may be formed of at least dipole antenna 108A, monopole antenna 106A, and monopole antenna 500 whose angle of disposition with respect to monopole antenna 106A is a variable.

Further, monopole antenna 500 formed on the same plane as fixed monopole antenna 106A and dipole antenna 108A prevents antenna 100C itself from being structured three-dimensionally, which enables downsizing.

Here, monopole antenna 500 can be rotated substantially 360 degrees. Changing mechanism 503 may be capable of continuously rotating monopole antenna 500, like a pan head for fixing a camera or telescope to a stand (e.g. tripod). Further, a stopper mechanism (not shown) may be added. The stopper mechanism fixes the rotation angle of monopole antenna 500 discontinuously to facilitate setting the rotation angle by the user.

As described above, monopole antenna 500 is rotated manually; however, the embodiment is not limited to this configuration, but the angle of monopole antenna 500 can be set automatically according to reception conditions by control unit 512 provided. To set the angle of monopole antenna 500 automatically, the following two setting ways may be used.

As described above, antenna 100C of the embodiment receives vertically polarized waves by monopole antenna 106A; horizontally polarized waves, by dipole antenna 108A. Hence in the first automatic setting way, control unit 512 first determines which reception level is higher, that of vertically polarized waves received by fixed monopole antenna 106A or that of horizontally polarized waves received by dipole antenna 108A, on the basis of a signal input from detecting unit 510.

Next, if the reception level of horizontally polarized waves is higher than that of vertically ones, control unit 512 changes the angle of monopole antenna 500 to that at which horizontally polarized waves can be received. Meanwhile, if the reception level of vertically polarized waves is higher than that of horizontally ones, control unit 512 changes the angle of monopole antenna 500 to that at which vertically polarized waves can be received. In other words, the angle at which monopole antenna (sixth linear line) 500 is disposed with respect to monopole antenna 106A is changed so as to receive polarized waves with a higher reception level, vertically or horizontally ones received by monopole antenna 106A or dipole antenna 108A.

With the above-described configuration, monopole antenna 500 capable of automatically changing the angle, in addition to fixed monopole antenna 106A and dipole antenna 108A, enables receiving radio waves at a high reception level without requiring the user to change the angle, which enhances the reception level.

In the above-described first automatic setting way, the angle of monopole antenna 500 is automatically set. As shown in FIG. 5 for instance, monopole antenna 500 is disposed extremely close to fourth linear line 300, sometimes causing monopole antenna 500 to be coupled with fourth linear line 300 (interfering with each other).

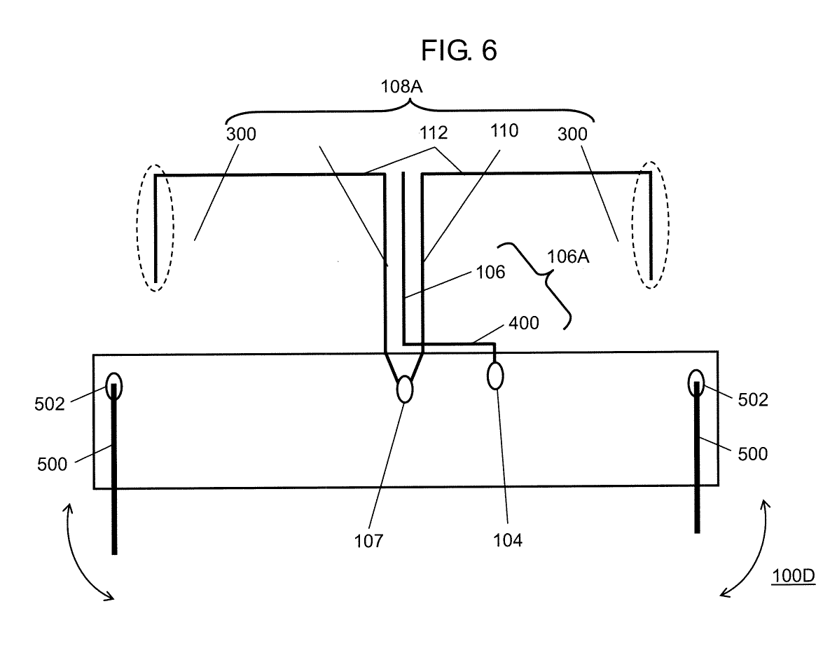

Hence in the second automatic setting way, as shown in FIG. 6, the angle at which monopole antenna (sixth linear line) 500 is disposed with respect to above-described monopole antenna 106A that receives vertically or horizontally polarized waves is changed in the direction (upward in the diagram) opposite to the direction (downward in the diagram) in which first linear line 106 is disposed from above-described first feeding point 104. The diagram excludes changing mechanism 503 and receiving unit 516 for simplification.

With the above-described configuration, monopole antenna 500 capable of changing the angle, in addition to fixed monopole antenna 106A and dipole antenna 108A, enables receiving radio waves at a high reception level while preventing mutual interference due to coupling between the antennas, which enhances the reception level.

In the above-described embodiment, monopole antenna 500 is formed on the same plane as fixed monopole antenna 106A and dipole antenna 108A for downsizing; however, the following setting can be made. That is, control unit 512 can change the angle of monopole antenna 500 to a space away from the same plane only when radio waves cannot be received by any of fixed monopole antenna 106A, dipole antenna 108A, and monopole antenna 500, for instance.

In the above-described configuration, dipole antenna 108A receives horizontally polarized waves, and monopole antenna 106A receives vertically polarized waves; however, the reverse case is practicable as well.

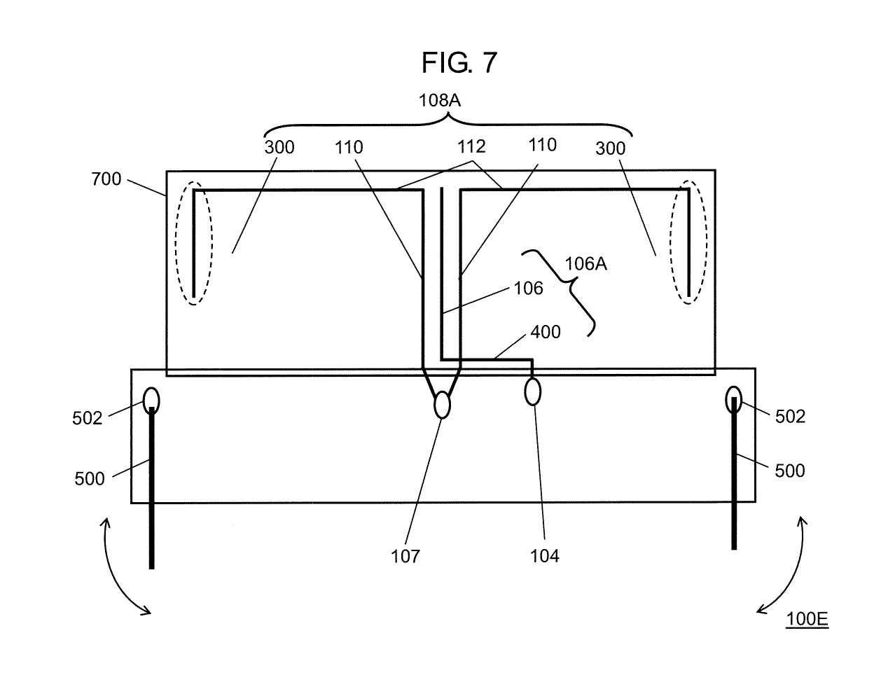

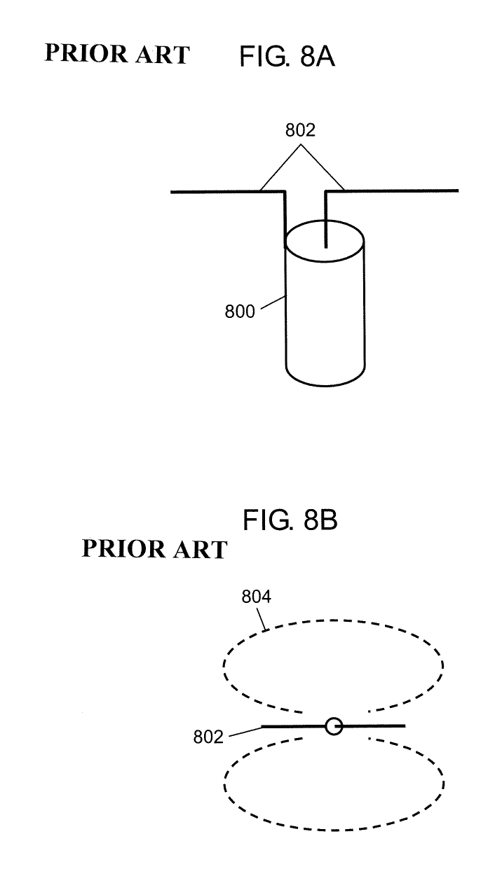

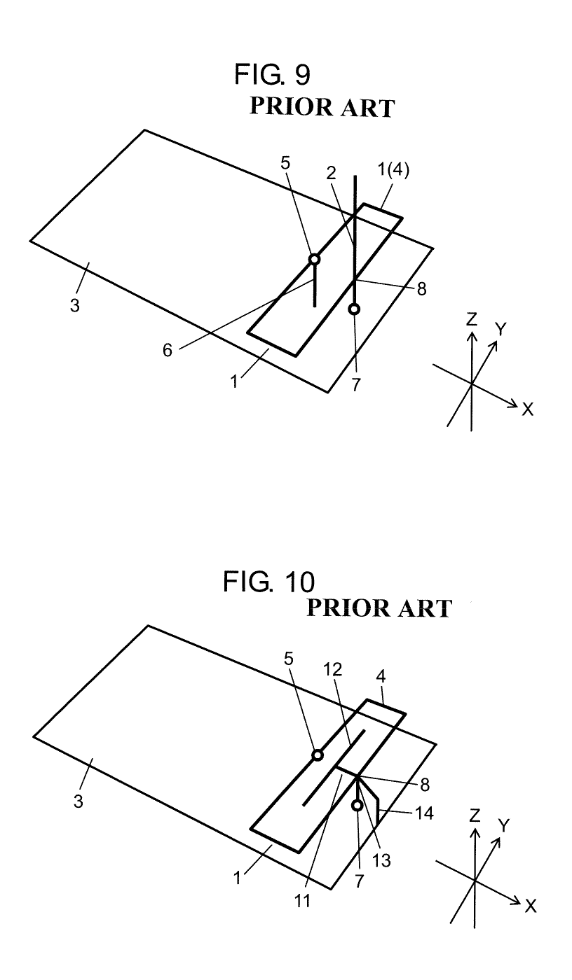

In the above configuration, the description is made of an example where dipole antenna 108A and monopole antenna 106A are disposed in the air. However, the embodiment is practicable with the following structure as well. That is, as shown in FIG. 7, at least either one of monopole antenna 106A and dipole antenna 108A is embedded into acrylic plate 700 for instance, and is resin-sealed and fixed to ensure strength.

As described above, this embodiment is applicable to a reception apparatus including demodulating unit 514 for demodulating radio waves received from antenna 100C. That is, a reception apparatus according to the embodiment includes antenna 100C capable of receiving radio waves. Antenna 100C includes monopole antenna 106A connected to first feeding point 104 and is formed of at least first linear line 106; and dipole antenna 108A having plural linear lines connected to second feeding point 107. The reception apparatus further includes demodulating unit 514 for demodulating radio waves received by either monopole antenna 106A or dipole antenna 108A.

Then, dipole antenna 108A has second linear line 110 formed of plural linear lines disposed substantially equidistant from first linear line 106 and substantially parallel to first linear line 106; and third linear line 112 formed substantially orthogonal to second linear line 110. Then, electric currents are excited through the plural linear lines forming second linear line 110 in directions opposite to each other. Further, monopole antenna 106A is formed on substantially the same plane as dipole antenna 108A. Such a configuration enables receiving a larger number of radio waves having plural planes of polarization.

### INDUSTRIAL APPLICABILITY

The present invention is applicable to a reception apparatus for receiving such as broadcast waves, particularly to a reception apparatus including a monopole antenna and a dipole antenna.

### Reference Marks in the Drawings

100 Antenna
100A Antenna
100B Antenna
100C Antenna
102 Finite ground plate
104 First feeding point
106 Monopole antenna (first linear line)
106A Monopole antenna
107 Second feeding point
108 Dipole antenna
108A Dipole antenna
108B Dipole antenna
110 Second linear line
112 Third linear line
200 Broken line
204 Arrow
206 Antenna end
208 Antenna end
300 Fourth linear line
400 Fifth linear line
500 Monopole antenna (sixth linear line)
502 Third feeding point
503 Changing mechanism
510 Detecting unit
512 Control unit
514 Demodulating unit
516 Receiving unit
700 Acrylic plate

1. An antenna capable of receiving a radio wave, comprising:
a monopole antenna connected to a first feeding point and including at least a first linear line; and
a dipole antenna connected to a second feeding point and including a plurality of linear lines,
wherein the dipole antenna includes:
a second linear line having a plurality of linear lines disposed substantially equidistant from the first linear line and substantially parallel to the first linear line; and
a third linear line connected to the second linear line and being substantially orthogonal to the second linear line,
wherein electric currents are excited through the plurality of linear lines of the second linear line in directions opposite to each other,
wherein the monopole antenna is on substantially the same plane as the dipole antenna.

2. The antenna according to claim 1,
wherein the dipole antenna is further connected to the third linear line and includes a fourth linear line substantially orthogonal to the third linear line,
wherein the fourth linear line is away from the monopole antenna by not smaller than λ/4, where λ represents a wavelength of a radio wave having a maximum wave length out of radio waves receivable by the antenna.

3. The antenna according to claim 1,
wherein the monopole antenna further includes a fifth linear line substantially orthogonal to the first linear line,
wherein the fifth linear line is connected to the first feeding point.

4. The antenna according to claim 1,
wherein the antenna includes a sixth linear line that is on substantially the same plane as the dipole antenna and is connected to a third feeding point, and an angle at which the sixth linear line is disposed with respect to the monopole antenna is changeable,
wherein the sixth linear line is capable of receiving both vertically and horizontally polarized waves.

5. The antenna according to claim 4,
wherein an angle at which the sixth linear line is disposed with respect to the monopole antenna is changed so as to receive either a vertically polarized wave or a horizontally polarized wave received by the monopole antenna or the dipole antenna, whichever has a higher reception level.

6. The antenna according to claim 4,
wherein an angle at which the sixth linear line is disposed with respect to the monopole antenna is changed so as to receive a vertically or horizontally polarized wave, in a direction opposite to a direction in which the first linear line is disposed from the first feeding point.

7. The antenna according to claim 1, wherein at least either one of the monopole antenna and the dipole antenna is resin-sealed and fixed to.

8. A reception apparatus including an antenna capable of receiving a radio wave,
wherein the antenna includes:
a monopole antenna connected to a first feeding point and including at least a first linear line; and
a dipole antenna connected to a second feeding point and including a plurality of linear lines,
wherein the reception apparatus includes a demodulating unit for demodulating a radio wave received by at least either one of the monopole antenna and the dipole antenna,
wherein the dipole antenna includes:
a second linear line having a plurality of linear lines disposed substantially equidistant from the first linear line and substantially parallel to the first linear line; and
a third linear line connected to the second linear line and being substantially orthogonal to the second linear line,
wherein electric currents are excited through the plurality of linear lines of the second linear line in directions opposite to each other,
wherein the monopole antenna is on substantially the same plane as the dipole antenna.

9. A reception apparatus including an antenna capable of receiving a radio wave,
wherein the antenna includes:
three or more different feeding points;
an antenna group connected to the feeding points, capable of receiving three or more independent polarized waves; and
a demodulating unit for demodulating a radio wave received by the antenna group.

10. The reception apparatus according to claim 9,
wherein the antenna group includes at least a dipole antenna, a first monopole antenna, and a second monopole antenna that is disposed relative to the first monopole antenna at a variable angle.
